(19) United States
(12) Patent Application Publication
(10) Pub. No.: US 2024/0200373 A1
(43) Pub. Date: Jun. 20, 2024

(54) FIXED SASH RETAINER SYSTEM FOR FENESTRATION UNIT

(71) Applicant: JELD-WEN, Inc., Charlotte, NC (US)

(72) Inventors: Eric John Wilson, Klamath Falls, OR (US); John Corder, Klamath Falls, OR (US)

(73) Assignee: JELD-WEN, Inc., Charlotte, NC (US)

(21) Appl. No.: 18/545,400

(22) Filed: Dec. 19, 2023

Related U.S. Application Data
(60) Provisional application No. 63/476,225, filed on Dec. 20, 2022.

(51) Int. Cl. E05C 3/16; E05C 3/00; E06B 1/36; E06B 3/28

(52) U.S. Cl. CPC E05C 3/16; E05C 3/006; E06B 1/36; E06B 3/28

(57) ABSTRACT

A fixed sash retainer system for a fenestration unit is disclosed. The retainer system includes a first and a second coupling member. The second coupling member is resiliently flexible between a first position and a second position. The second coupling member is configured to engage the first coupling member when in the first position and to disengage when in the second position. The second coupling member has a key feature configured to cooperate with the one of the sash and the frame to define a key slot. The key slot is configured to receive and engage a key that selectively retains the second coupling member in the second position.

### CROSS-REFERENCE TO RELATED APPLICATIONS

This application claims priority to U.S. Provisional Application No. 63/476,225, filed Dec. 20, 2022, the entire disclosure of which is incorporated by reference herein.

### TECHNICAL FIELD

The present disclosure generally relates to a fenestration unit and, more particularly, relates to a fixed sash retainer system for a fenestration unit.

### BACKGROUND

A fenestration unit may include a fixed sash (i.e., a non-operating transparent fenestration panel). The fixed sash often includes a frame and a sash with a pane of glass or other material (i.e., glazing, etc.). In a fixed window unit, for example, the frame is secured to the wall of a building, and the sash (the portion that supports glass) is supported in the frame. Often, the sash is fastened (e.g., secured with screws) directly to the frame before the glass is installed and glazed with a sealant to prevent leaking.

One fault of existing fenestration systems and methods is that if the glass breaks or there is ever damage to any part of the sash, the entire fenestration unit may need to be destroyed to access the fasteners and remove the unit. Additionally, glazing the glass on-site at an installation can be difficult and time consuming.

Accordingly, it is desirable to provide an improved system for installing and removing the sash from the frame, for example, in a fixed sash (i.e., non-operating) fenestration unit. Other desirable features and characteristics of the present disclosure will become apparent from the subsequent detailed description and the appended claims, taken in conjunction with the accompanying drawings and this background discussion.

### BRIEF SUMMARY

A fixed sash retainer system for a fenestration unit is disclosed. The retainer system includes a first coupling member for one of a sash and a fenestration frame. The retainer system also includes a second coupling member for the other of the sash and the fenestration frame. The first and second coupling members have an engaged condition in which the first and second coupling members are removably engaged to removably and fixedly attach the sash to the fenestration frame. The first coupling member is rigid and has a seating strip and a clip hook. The seating strip has a seat surface that faces in a first direction toward and abuts the one of the sash and the fenestration frame. The clip hook protrudes from the seating strip in a second direction opposite the first direction. The clip hook has a solid, tapered cross-sectional profile that defines a hooked underside of the first coupling member. Furthermore, the second coupling member is resiliently flexible between a first position and a second position. The second coupling member is configured to be in the engaged condition with the first coupling member when in the first position. The second coupling member is configured to be in a disengaged condition with the first coupling member when in the second position. The second coupling member has a key feature configured to cooperate with the one of the sash and the frame to define a key slot. The key slot is configured to receive and engage a key that selectively retains the second coupling member in the second position.

Also, a fenestration unit is disclosed that includes a sash that supports a transparent pane. The fenestration unit also includes a fenestration frame, a first coupling member attached to one of a sash and the fenestration frame, and a second coupling member attached to the other of the sash and the fenestration frame. The first and second coupling members have an engaged condition in which the first and second coupling members are removably engaged to removably and fixedly attach the sash to the fenestration frame. The first coupling member is rigid and has a seating strip and a clip hook. The seating strip has a seat surface that faces in a first direction toward and abuts the one of the sash and the fenestration frame. The clip hook protrudes from the seating strip in a second direction opposite the first direction. The clip hook has a solid, tapered cross-sectional profile that defines a hooked underside of the first coupling member. The second coupling member is resiliently flexible between a first position and a second position. The second coupling member is in the engaged condition with the first coupling member when in the first position. The second coupling member is in a disengaged condition with the first coupling member when in the second position. The second coupling member has a key feature configured to cooperate with the one of the sash and the frame to define a key slot. The key slot is configured to receive and engage a key that selectively retains the second coupling member in the second position.

Moreover, a method of manufacturing a fenestration unit is disclosed that includes providing a sash configured for supporting a transparent pane. The method also includes providing a fenestration frame, attaching a first coupling member to one of the sash and the fenestration frame, and attaching a second coupling member to the other of the sash and the fenestration frame. The method further includes removably engaging the first and second coupling members into an engaged condition to removably and fixedly attach the sash to the fenestration frame. The first coupling member is rigid and has a seating strip and a clip hook. The seating strip has a seat surface that faces in a first direction toward and abuts the one of the sash and the fenestration frame. The clip hook protrudes from the seating strip in a second direction opposite the first direction. The clip hook has a solid, tapered cross-sectional profile that defines a hooked underside of the first coupling member. The second coupling member is resiliently flexible between a first position and a second position. The second coupling member is in the engaged condition with the first coupling member when in the first position, and the second coupling member is in a disengaged condition with the first coupling member when in the second position. The second coupling member has a key feature configured to cooperate with the one of the sash and the frame to define a key slot. The key slot is configured to receive and engage a key that selectively retains the second coupling member in the second position. At least one specification heading is required. Please delete this heading section if it is not applicable to your application. For more information regarding the headings of the specification, please see MPEP 608.01(a).

### BRIEF DESCRIPTION OF DRAWINGS

The present disclosure will hereinafter be described in conjunction with the following drawing figures, wherein like numerals denote like elements, and wherein:

FIG. 1 is a schematic view of a fenestration unit with a fixed sash retainer system according to example embodiments of the present disclosure;

FIG. 2 is an isometric view of the fenestration unit of FIG. 1 from another perspective;

FIG. 3 is an isometric view of a first coupling member (i.e., a catch, a striker, etc.) of the fixed sash retainer system according to example embodiments of the present disclosure;

FIG. 4 is an isometric view of a second coupling member (i.e., a latch, a lock clip, a spring-biased member, etc.) of the fixed sash retainer system according to example embodiments;

FIG. 5 is an isometric view of a key (i.e., a clip removal tool, etc.) of the fixed sash retainer system according to example embodiments;

FIG. 6 an isometric view of the fixed sash retainer system in an engaged condition according to example embodiments; and

FIG. 7 is a cross-sectional view of the fixed sash retainer system shown moving between the engaged condition and a disengaged condition according to example embodiments of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Broadly, example embodiments disclosed herein include a fixed sash retainer system for a fenestration unit. In some embodiments, the fixed sash retainer system comprises a first coupling member, a second coupling member, and a removal key tool. One of the coupling members is attached to and/or located on the frame, and the other is attached to and/or located on the sash. When the sash is installed into the frame, the coupling members interlock removably, for example, snapping into place for a snap-fit. The key may be inserted between the sash and frame (e.g., from the inside of the dwelling) and may engage therein while also abutting with the one of the coupling members and wedging it into a position where the coupling members are disengaged. Thus, the coupling members may be held in a disengaged condition, and the sash and the pane may be conveniently removed from the frame.

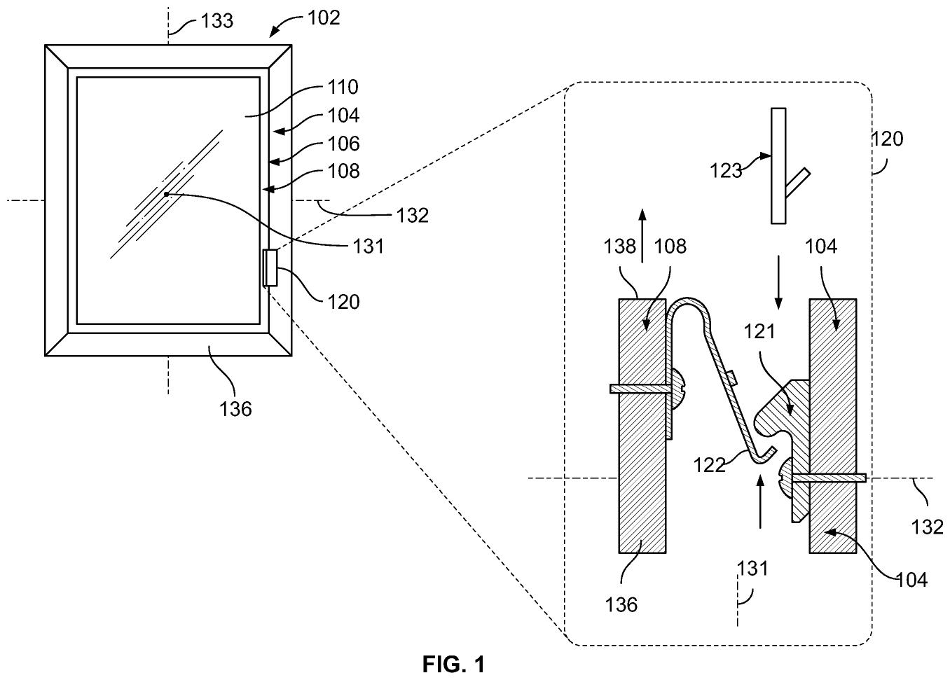

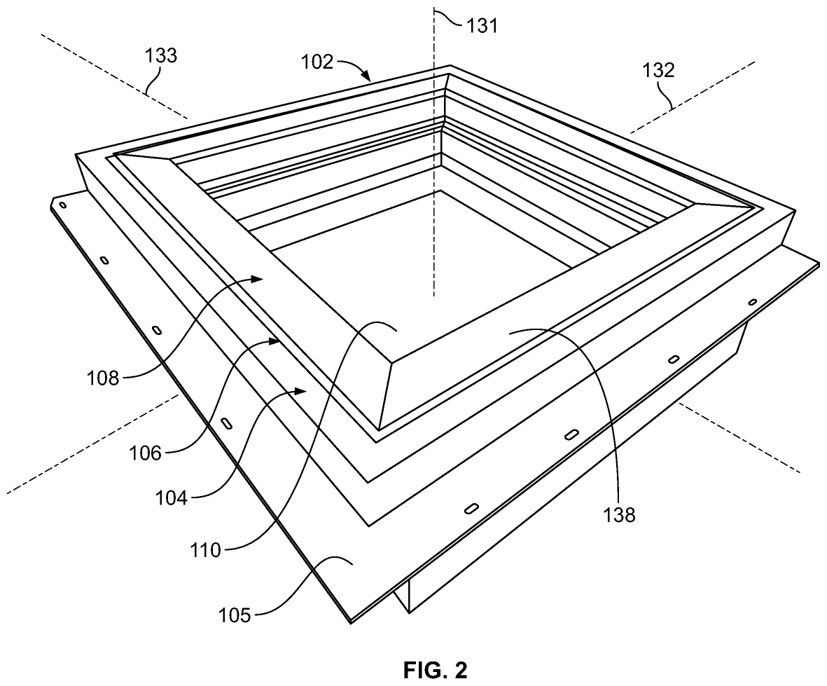

Referring initially to FIGS. 1 and 2, a fenestration unit 102 is illustrated according to example embodiments. The fenestration unit 102 may be a window unit in some embodiments; however, it will be appreciated that the fenestration unit 102 may be a transom, skylight, sidelite, or other fenestration unit 102 without departing from the scope of the present disclosure.

Generally, the fenestration unit 102 may include a fenestration frame 104 that defines a fenestration opening 106 for a structure, such as a house, shed, or other dwelling. The frame 104 may be constructed from hollow, lineal members. The members may be formed via an extrusion process. The frame 104 may be constructed from aluminum, composite material, steel, or another material. The fenestration frame 104 may include a nail fin 105 (FIG. 2) or nail flange that extends outwardly therefrom for installation into a rough opening of the dwelling. The fenestration unit 102 may also include a sash 108, which supports a transparent pane 110 (e.g., a unit with one or more panes of glass, an insulated glazing unit, etc.) The sash 108 (i.e., the sash frame) may extend about the entire periphery of the transparent pane 110 and may be rectangular. The sash 108 may correspond in shape to be received in the rectangular fenestration opening 106 of the frame 104.

The sash 108 may be fixedly and removably attached to the frame 104 to be supported within the fenestration opening 106 by a fixed sash retainer system 120. The retainer system 120 may generally include a first coupling member 121 for either the sash 108 or the frame 104, and the retainer system 120 may also generally include a second coupling member 122 for the other.

The first and second coupling members 121, 122 may have an engaged condition in which the first and second coupling members 121, 122 are removably engaged to be removably and fixedly attach the sash 108 to the fenestration frame 104. As shown in FIG. 1 and as will be discussed, the retainer system 120 may include a key 123 (i.e., removal tool, snap-fit insert, key card, etc.), which may be inserted between the sash 108 and the frame 104 to thereby disengage the first and second coupling members 121, 122. Once disengaged (i.e., once the first and second coupling members 121, 122 are in the disengaged condition), the sash 108 may be removed from the frame 104. In some embodiments, the key 123 may be inserted and snap-fit between the sash 108 and frame 104 such that the key 123 holds and retains the first and second coupling members 121, 122 in the disengaged condition. Accordingly, the sash 108 may be conveniently removed from the frame 104 while the key 123 maintains disengagement between the first and second coupling members 121, 122.

The fenestration unit 102 may define a Cartesian coordinate system with a first axis 131 extending normal to the pane 110 (i.e., in an interior-exterior direction), a second axis 132 extending horizontally and transversely across the fenestration opening 106, and a third axis 133 extending vertically across the fenestration opening 106. Also, the fenestration unit 102 may define a first side 136 and a second side 138 that are spaced apart and that face in opposite directions along the first axis 131. In some embodiments, the first side 136 (FIG. 1) may an exterior side of the fenestration unit 102 configured for facing out of the structure or dwelling, and the second side 138 (FIG. 2) may be an interior side of the fenestration unit 102 configured for facing into the structure or dwelling.

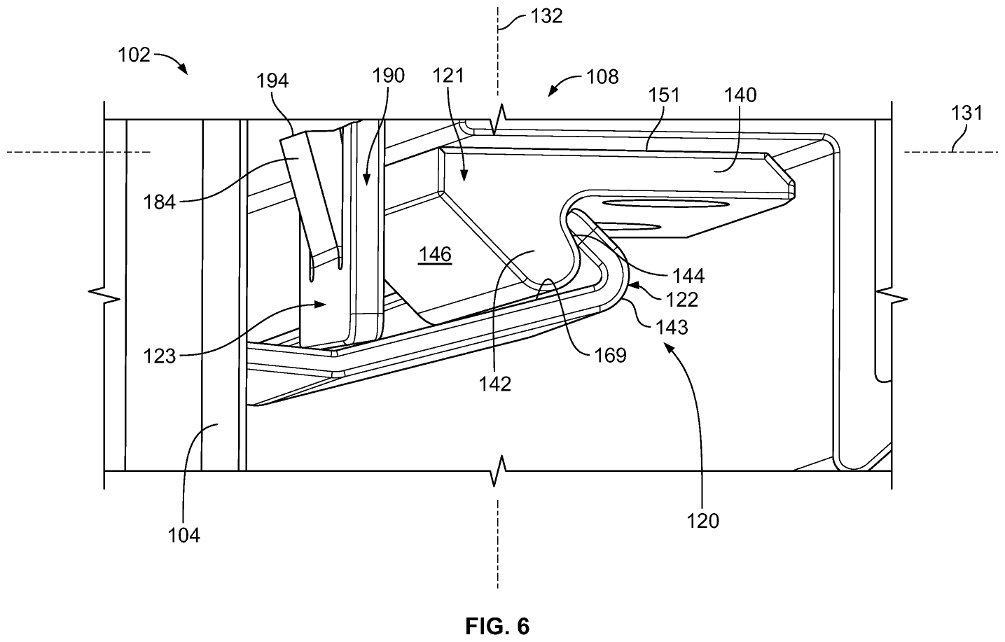

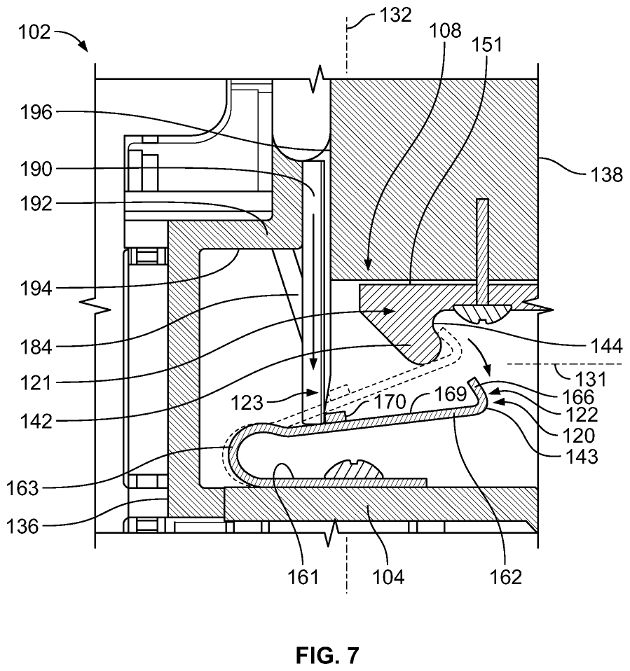

As shown in the embodiments of FIG. 1, the first coupling member 121 may be attached to the frame 104 while the second coupling member 122 may be attached to the sash 108. In other embodiments represented in FIGS. 6 and 7, the first coupling member 121 may be attached to the sash 108, and the second coupling member 122 may be attached to the frame 104. Accordingly, it will be appreciated that the sash retainer system 120 may have a number of variations without departing from the scope of the present disclosure.

As indicated in FIG. 1, the first and second coupling members 121, 122 of the sash retainer system 120 may be included along the vertically-extending jamb of the fenestration unit 102. It will be appreciated that the first and second coupling members 121, 122 may be paired, arranged, and positioned at other locations about the fenestration opening 106 (e.g., at the sill area and/or the header area) for retaining the sash 108. There may be a plurality of pairings of the first and second coupling members 121, 122 arranged about the periphery of the fenestration opening 106.

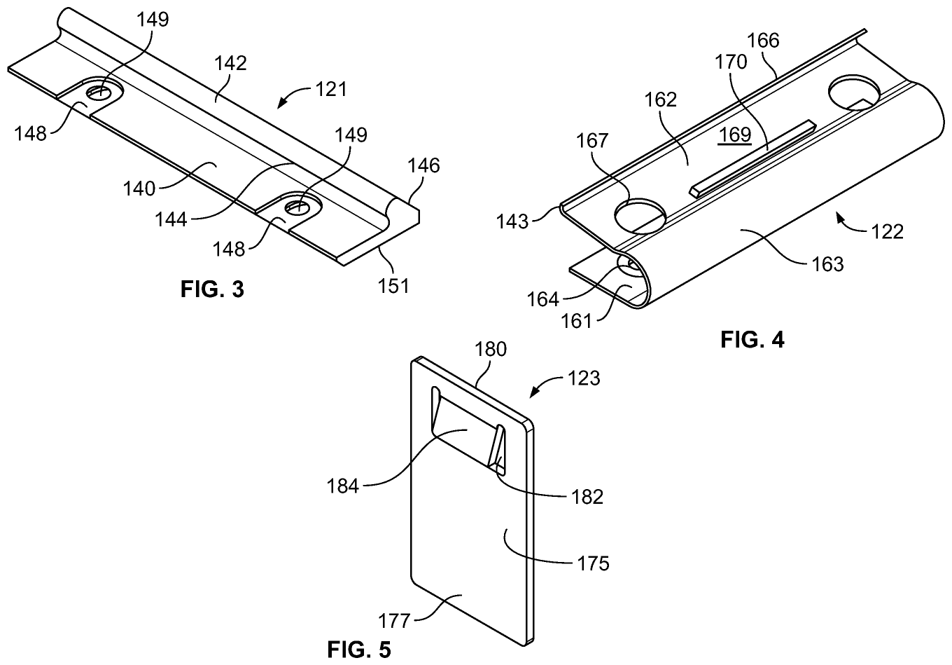

As shown in FIG. 3, the first coupling member 121 (i.e., a rigid catch) may be a unitary, monolithic, one-piece rigid and strong member. The first coupling member 121 may include an elongate seating strip 140 and a clip hook 142. The seating strip 140 may be relatively flat with a first side 151 that faces along the second axis 132 toward the sash 108. The clip hook 142 may protrude from the seating strip 140 in an opposite direction along the second axis 132 and away from the sash 108. As shown in FIGS. 6 and 7, the clip hook 142 may have a solid, tapered cross-sectional profile. Also, the clip hook 142 may include an angled face 146. A majority of the face 146 may lie within a plane that is disposed at a positive angle relative to the seating strip 140. The face 146 may be configured to interface with a corresponding angled face of the second coupling member 122 as will be discussed. The smooth, rounded, and contoured top surface of the face 146 may continue and extend into an overarching “S” shape so as to define a hooked underside 144 of the clip hook 142. The underside 144 may substantially face toward the seating strip 140, and the underside 144 may be designed to engage with the second coupling member 122. It will be appreciated that the solid, tapered cross-sectional profile of the clip hook 142 provides robust coupling to the second coupling member 122. This profile also facilitates selective disengagement from the second coupling member 122.

The first coupling member 121 may be constructed of and/or may include a variety of materials, such as relatively hard, strong, and rigid, polymeric material (e.g., injection-molded plastic). The shape of the first coupling member 121 may be configured such that, when loads are applied to the fenestration unit 102, the shape of the first coupling member 121 forces the second coupling member 122 to further engage the first coupling member 121, thereby robustly attaching the sash 108 to the frame 104.

As shown in FIG. 3, the seating strip 140 of the first coupling member 121 may include fastener recesses 148 about respective fastener openings 149. The openings 149 may receive fasteners that attach the first coupling member 121 to the sash 108 (FIGS. 6 and 7). The recesses 148 allow the fastener to sit lower (i.e., more flush) on the seating strip 140, giving additional clearance for the second coupling member 122 to engage over the first coupling member 121 without concern of the fastener-head interfering with the latching action. In some embodiments, the first coupling member 121 may also have one or more ribs (e.g., on the underside of the part to aid in stiffening of the part and to reduce part material volume.

In some embodiments, the first coupling member 121 may be a molded, polymeric part. Voids of the first coupling member 121 may include, for example, a 45-degree release with a 1-degree face draft on all surfaces. There may be a hole feature that is released at a 45-degree, thereby leaving no seam from tool removal on the hole feature. Furthermore, the first coupling member 121 may include an angled relief, which may be used for locating the first coupling member 121 prior to installation.

As shown in FIG. 4, the second coupling member 122 (i.e., latch, spring grip, etc.) may comprise a high-strength sheet of hardened material. The second coupling member 122 may be resiliently flexible to provide bias/spring forces and resilient flexure between two or more positions. In some embodiments, the second coupling member 122 may be constructed from and/or include bent stainless-steel sheet material. The second coupling member 122 may be made from and may comprise sheet with a plurality of holes, a rounded/bent segment, a key stop feature, and/or other features.

The second coupling member 122 may comprises a flexible sheet of substantially constant thickness with a first portion 161 and a second portion 162 that are joined at a flexible joint 163. The first portion 161 may be substantially flat and planar with one or more fastener holes 164 for attachment to the fenestration frame 104 (FIGS. 6 and 7). The joint 163 may be rounded, semi-circular, and bent to a suitable radius for providing predetermined spring stiffness. The joint 163 of the second coupling member 122 may be bent into a radius that so that the second coupling member 122 doubles back on itself. The second portion 162 may be disposed on the other side of the joint 163. A majority of the second portion 162 may be relatively flat and planar. The second portion 162 may be bent to double back again, thereby defining a hooked tip 166 at the terminal edge thereof. The hooked tip 166 may be bent into a small radius which tips the second coupling member 122 upward at a prescribed angle. The hooked tip 166 may be shaped and otherwise configured to interface with the first coupling member 121. Also, the second portion 162 may define an engagement surface 169 (i.e., a striking face), which interfaces with the first coupling member 121 as will be discussed.

The second portion 162 may further include access holes 167 (FIG. 4), which are aligned with respective ones of the fastener holes 164. The access holes 167 may provide passage for fastener heads to pass-through and into the fastener holes 164 during attachment to the frame 104 (FIGS. 6 and 7).

The second coupling member 122 may be resiliently flexible for movement between a first position and a second position. In FIG. 6, the first position is shown in phantom, and the second position is shown in solid lines. As shown, the second portion 162 may move angularly toward the first portion 161 and the radius of the joint 163 may change as the second coupling member 122 flexes from the first position toward the second position. Thus, the second portion 162 may be pressed or otherwise forced toward the second position as represented in FIG. 6. When this force is removed, the joint 163 may resiliently recover toward an unbiased position and toward the first position shown in phantom in FIG. 6.

Moreover, the second coupling member 122 may include a key feature, such as a protruding key stop 170 that protrudes from a surrounding surface of the second portion 162 of the second coupling member 122. The key stop 170 may be a straight, elongate rib that protrudes from the engagement surface 169, adjacent the joint 163. As shown in FIG. 7 and as will be discussed, the key stop 170 may provide a hard stop (i.e., a surface to push against or otherwise engage) for the removal tool key 123 during use. The key stop 170 may engage the key 123, preventing the key 123 from sliding up the engagement surface 169 (i.e., the key may limit relative movement of the key 123 along the surface 169). Also, the key stop 170 may allow for the key 123 to wedge itself between the second coupling member 122, the frame 104, and the sash 108, keeping the second coupling member 122 held in the second position, disengaged from the first coupling member 121. Keys 123 may be used for each of the pairs of coupling members 121, 122 in the fenestration unit 102, and the sash 108 may then be removed from the frame 104.

The key 123 is shown according to example embodiments in FIG. 5. The key 123 may include a key body 175 that is generally flat, rectangular, and card-like. One end of the key body 175 may define a head 180, and a handle end 177 may be separated apart from the head 180 across the key body 175. The head 180 may include an opening 182, and the key 123 may include a tab 184 that is attached within the opening 182. The tab 184 may be supported for resilient flexure within the opening 182. In an unbiased first position (FIG. 5), part of the tab 184 may extend out of the opening 182 and away from the head 180 of the key body 175. The tab 184 may resiliently flex and flatten into the opening 182 to be substantially flush with and proximate the head 180. The tab 184 may also be biased toward the first position shown in FIG. 5.

The key 123 may be constructed from and/or include a plastic material. The material of the key 123 may be chosen to reduce the likelihood of damage to the frame 104 or sash 108 when being inserted for removal of the sash 108. In some embodiments, the key 123 may be formed via an injection molding process. Also, in some embodiments, the key 123 may be dimensioned, shaped, and otherwise configured to fit between the sash 108 and frame 104 to disengage the first and second coupling members 121, 122. In some embodiments, the key 123 may be configured to snap-fit between the sash 108 and frame 104 while retaining the second coupling member 122 in the disengaged position.

During installation of the fenestration unit 102, the fenestration frame 104 may be installed or otherwise provided within the rough opening of the dwelling, for example, using the nail fin 105 (FIG. 2). The fenestration opening 106 may remain open and the sash 108 may remain separate from the frame 104 during installation of the frame 104.

Next, as shown in FIGS. 6 and 7, the first coupling members 121 may be fixedly attached to the sash 108 and the second coupling members 122 may be fixedly attached to the frame 104. The coupling members 121, 122 may be positioned so as to align with each other when the sash 108 is installed.

To install the sash 108, the sash 108 may be advanced into the fenestration opening 106, substantially along the first axis 131 from the second side 138 toward the first side 136. As the sash 108 advances along this direction, the angled face 146 may ramp and cam against an opposing edge 143 of the hooked tip 166. Accordingly, the angled face 146 may resiliently flex the second coupling member 122 from the first position (shown in phantom in FIG. 7) toward the second position (shown in solid lines in FIG. 7). The hooked tip 166 may hook into and clip over the tapered clip hook 142, and the second coupling member 122 may resiliently recover toward the first position, coming to rest with the tip 166 hooked over and onto the underside 144 of the tapered clip hook 142. Accordingly, this may be a highly robust engaged condition of the fixed sash retainer system 120.

As shown in FIG. 7, the sash 108, the frame 104, and the second coupling member 122 may cooperate to define a key slot 190 for the key 123. More specifically, the frame 104 may include a pane stop 192 that faces the sash 108 in opposite directions along the first axis 131. The frame 104 may also include an interior underside surface 194 on the pane stop 192. The pane stop 192 and the sash 108 may cooperate to define an opening 196 to the key slot 190. Further inside, the sash 108, the underside surface 194, and the second coupling member 122 may be spaced apart at predetermined distances to define the size and shape of the key slot 190. These features may be sized and shaped for snap-fit attachment of the key 123.

To remove the sash 108, the user may hold the handle end 177 and slidingly insert the head 180 into the opening 196. The tab 184 may resiliently flex and flatten to allow the key 123 to advance into the key slot 190. As the head 180 abuts the second coupling member 122, the head 180 may engage the key stop 170, and the key 123 may bend and resiliently flex the second coupling member 122 toward the disengaged position. Eventually, the key 123 may advance far enough into the key slot 190 to allow the tab 184 to recover and seat against the underside surface 194 of the frame 104. Thus, the key 123 may be snap-fit into position to retain the second coupling member 122 in the disengaged position. Each of the second coupling members 122 of the fenestration unit 102 may be disengaged with respective keys 123, and then the sash 108 may be moved out of the fenestration opening 106 along the first axis 131. Thus, in some embodiments, the sash 108 may be conveniently removed from the second side 138 (e.g., the interior side of the dwelling).

While existing installation methods include screwing a sash into a frame prior to installing and glazing an insulated glazing unit into the sash, the installation method of the present disclosure makes removal of the sash 108 possible without deglazing the pane 110 and removing it from the sash 108. Accordingly, the system 120 may provide time-savings and convenient installation and removal of the sash 108. The sash retainer system 120 allows the sash 108 to be installed with the pane 110 already glazed to the sash 108, making installation in the factory easier as well as in the field. The system 120 may allow for in-field warranty repair/replacement of fixed casement windows. The retainer system 120 may also decrease manufacturing complexity.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

What is claimed is:

1. A fixed sash retainer system for a fenestration unit comprising:
a first coupling member for one of a sash and a fenestration frame;
a second coupling member for the other of the sash and the fenestration frame, the first and second coupling members having an engaged condition in which the first and second coupling members are removably engaged to removably and fixedly attach the sash to the fenestration frame;
the first coupling member being rigid and having a seating strip and a clip hook, the seating strip having a seat surface that faces in a first direction toward and abuts the one of the sash and the fenestration frame, the clip hook protruding from the seating strip in a second direction opposite the first direction, the clip hook having a solid, tapered cross-sectional profile that defines a hooked underside of the first coupling member; and
the second coupling member being resiliently flexible between a first position and a second position, the second coupling member is configured to be in the engaged condition with the first coupling member when in the first position, the second coupling member is configured to be in a disengaged condition with the first coupling member when in the second position, the second coupling member having a key feature configured to cooperate with the one of the sash and the fenestration frame to define a key slot, the key slot configured to receive and engage a key that selectively retains the second coupling member in the second position.

2. The fixed sash retainer system of claim 1, further comprising the key, the key configured to snap-fit into the key slot to retain the second coupling member in the second position.

3. The fixed sash retainer system of claim 2, wherein the key includes a head and a tab that is attached to the head and supported for resilient flexure between a first position and a second position relative to the head, the tab biased toward the first position, the tab projecting from the head in the first position, the tab positioned proximate the head in the second position and insertable into the key slot in the second position.

4. The fixed sash retainer system of claim 3, wherein the key includes comprises a key body that is substantially flat, the key body including the head and including a handle end, the handle end separated apart from the head across the key body, the head including an opening, the tab attached to the key body and supported for resilient flexure within the opening.

5. The fixed sash retainer system of claim 1, wherein the second coupling member comprises a flexible sheet of substantially constant thickness with a first portion and a second portion that are joined at a flexible joint, the first portion configured for attachment to the other of the sash and the fenestration frame.

6. The fixed sash retainer system of claim 5, wherein the second portion doubles back to define a hooked tip and an engagement surface, the engagement surface configured to abut the clip hook, and the hooked tip configured to hook into the hooked underside of the first coupling member when the second coupling member is in the engaged condition with the first coupling member.

7. The fixed sash retainer system of claim 1, wherein the first coupling member is constructed of a polymeric material.

8. A fenestration unit comprising:
a sash that supports a transparent pane;
a fenestration frame;
a first coupling member attached to one of the sash and the fenestration frame;
a second coupling member attached to the other of the sash and the fenestration frame, the first and second coupling members having an engaged condition in which the first and second coupling members are removably engaged to removably and fixedly attach the sash to the fenestration frame;
the first coupling member being rigid and having a seating strip and a clip hook, the seating strip having a seat surface that faces in a first direction toward and abuts the one of the sash and the fenestration frame, the clip hook protruding from the seating strip in a second direction opposite the first direction, the clip hook having a solid, tapered cross-sectional profile that defines a hooked underside of the first coupling member; and
the second coupling member being resiliently flexible between a first position and a second position, the second coupling member in the engaged condition with the first coupling member when in the first position, the second coupling member in a disengaged condition with the first coupling member when in the second position, the second coupling member having a key feature configured to cooperate with the one of the sash and the fenestration frame to define a key slot, the key slot configured to receive and engage a key that selectively retains the second coupling member in the second position.

9. The fenestration unit of claim 8, further comprising the key, the key configured to snap-fit into the key slot to retain the second coupling member in the second position.

10. The fenestration unit of claim 9, wherein the key includes a head and a tab that is attached to the head and supported for resilient flexure between a first position and a second position relative to the head, the tab biased toward the first position, the tab projecting from the head in the first position, the tab positioned proximate the head in the second position and insertable into the key slot in the second position.

11. The fenestration unit of claim 10, wherein the key includes comprises a key body that is substantially flat, the key body including the head and including a handle end, the handle end separated apart from the head across the key body, the head including an opening, the tab attached to the key body and supported for resilient flexure within the opening.

12. The fenestration unit of claim 10, wherein the first coupling member is attached to the sash and the second coupling member is coupled to the fenestration frame;
wherein the fenestration frame includes a pane stop and an underside surface;
wherein the pane stop and the sash cooperate to define an opening to the key slot; and
wherein the key feature and the underside surface cooperate to define the key slot.

13. The fenestration unit of claim 12, wherein the key feature is a protruding key stop that protrudes from a surrounding surface of the second coupling member; and
wherein the tab is configured to snap-fit against the underside surface with the head abutting against the key stop, thereby retaining the second coupling member in the second position.

14. The fenestration unit of claim 8, wherein the second coupling member comprises a flexible sheet of substantially constant thickness with a first portion and a second portion that are joined at a flexible joint, the first portion configured for attachment to the other of the sash and the fenestration frame.

15. The fenestration unit of claim 14, wherein the second portion doubles back to define a hooked tip and an engagement surface, the engagement surface configured to abut the clip hook, and the hooked tip configured to hook into the hooked underside of the first coupling member when the second coupling member is in the engaged condition with the first coupling member.

16. A method of manufacturing a fenestration unit comprising:
providing a sash configured for supporting a transparent pane;
providing a fenestration frame;
attaching a first coupling member to one of the sash and the fenestration frame;
attaching a second coupling member to the other of the sash and the fenestration frame;
removably engaging the first and second coupling members into an engaged condition to removably and fixedly attach the sash to the fenestration frame;
the first coupling member being rigid and having a seating strip and a clip hook, the seating strip having a seat surface that faces in a first direction toward and abuts the one of the sash and the fenestration frame, the clip hook protruding from the seating strip in a second direction opposite the first direction, the clip hook having a solid, tapered cross-sectional profile that defines a hooked underside of the first coupling member; and
the second coupling member being resiliently flexible between a first position and a second position, the second coupling member in the engaged condition with the first coupling member when in the first position, the second coupling member in a disengaged condition with the first coupling member when in the second position, the second coupling member having a key feature configured to cooperate with the one of the sash and the fenestration frame to define a key slot, the key slot configured to receive and engage a key that selectively retains the second coupling member in the second position.

17. The method of claim 16, further comprising providing the key, and snap-fitting the key into the key slot to retain the second coupling member in the second position.

18. The method of claim 17, further comprising snap-fitting the key between the fenestration frame and the key feature.

19. The method of claim 18, wherein the key feature is a protruding key stop that protrudes from a surrounding surface of the second coupling member.

20. The method of claim 16, wherein the second coupling member comprises a flexible sheet of substantially constant thickness with a first portion and a second portion that are joined at a flexible joint, the first portion configured for attachment to the other of the sash and the fenestration frame.
